(19) United States
(12) Patent Application Publication
(10) Pub. No.: US 2006/0031589 A1
(43) Pub. Date: Feb. 9, 2006

(54) System and method for automatically adjusting computer system times via a COM port

(75) Inventors: Jian-Feng Wang, Shen-Zhen (CN); Liang-Yan Dai, Shen-Zhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/191,392

(22) Filed: Jul. 28, 2005

(30) Foreign Application Priority Data
Mar. 9, 2004 (TW) 93126636

(51) Int. Cl. G06F 15/16

(52) U.S. Cl. 709/248

(57) ABSTRACT

A system for automatically adjusting computer system times via a COM port includes one or more computers (1) to be adjusted, and a time loading apparatus (2). Each computer includes: a setting module (10) for determining whether there is a new settings; a request generating module (11) for generating a time obtaining request, and transmitting the time obtaining request to the time loading apparatus; a searching module (13) for searching a time difference value of a destination in a time difference table; a converting module (14) for converting a current time received from the time loading apparatus into a system time of the destination, and converting the format of the current time into a stored time format if the current time format is different from the stored time format; and a system time adjusting module (15) for adjusting the system time of the computer. A related method is also disclosed.

### BACKGROUND OF THE INVENTION

1. Field of the Invention

The present invention pertains to configuring the system time of a computer according to the time zone in which the computer is to be located. More particularly, the present invention relates to automatically adjusting a computer's system time via a COM port.

2. Related Art

Accurate computer system times are required in a wide variety of applications, such as in managing and tracking electronic mail (email), timing back-ups of data on a network, synchronizing communications between clients and servers, and managing multimedia teleconferences. However, clients, servers and users are often located in different time zones, and the time differences must be taken into account appropriately. Further, the system times of most computers are subject to a certain amount of error, or “drift.”

Various techniques have been developed to adjust the system times of computers. Traditional techniques involve operators manually adjusting the system times. However, these techniques are inconvenient for operators and are subject to human error.

With the recent rapid development of network technology, techniques for adjusting system times through networks are gradually replacing traditional methods. A server maintains a highly accurate system time, and provides an accurate system time reading to other computers through a network. Methods for adjusting the system time of a computer through a network are disclosed in various patents. These methods involve adjusting system times of computers through reading a time server. However, the methods are inadequate when newly manufactured computers are shipped to a particular marketplace in a different time zone. Generally, it is desirable that the computers are appropriately pre-adjusted prior to dispatch. The above-described methods do not take into account the difference between the time zone in which the computer manufacturer is located and the time zone in which the marketplace is located.

In addition, the above-described methods do not address any conversion of the system time format of each computer that may be needed when the computer is shipped between the time zones. For example, in the country of the manufacturer, it may be customary for time to be expressed in a twelve-hour format, whereas in the country of the marketplace, it may be customary for time to be expressed in a twenty-four hour format. In such circumstances, upon arrival at destination, the system time of a computer is often incorrect. This is because the system time was adjusted to local time prior to dispatch, and/or because the time format of the computer is inappropriate.

Therefore, what is needed is a system and method for automatically adjusting computer system times via a COM port, which not only can adjust computer system times, but can also provide conversions of the time zone and/or the time format.

### SUMMARY

A main objective of the present invention is to provide a system and method for automatically adjusting computer system times through a COM port, which converts time zones and/or time formats appropriately.

To achieve the above objective, a system for automatically adjusting computer system times through a COM port in accordance with a preferred embodiment of the present invention comprises one or more computers whose system times are to be adjusted, and a time loading apparatus. Each computer stores a time difference table containing information on time zones and time difference values. The computer comprises a plurality of software function modules: a setting module for determining whether there is a new settings for a computer according to its destination; a request generating module for generating a time obtaining request, and transmitting the time obtaining request to the time loading apparatus; a searching module for searching a time difference value of the destination in the time difference table; a converting module for converting a current time received from the time loading apparatus into a system time of the destination according to the formula: system time of the destination=current time+time difference value of the destination, and converting the format of the current time if the stored time format is different from the format of the current time; and a system time adjusting module for adjusting system time of the computer according to the conversion.

Further, the present invention provides a preferred method for automatically adjusting computer system times through a COM port. The method comprises the steps of: (a) determining whether there is a new setting for a computer according to its destination; (b) receiving the new setting(s) and storing the new setting(s), if there is a new setting; (c) generating a time obtaining request, and transmitting the time obtaining request to a time loading apparatus via a COM port; (d) obtaining a current time of the time loading apparatus according to the time obtaining request, and transmitting the current time to the computer; (e) receiving the current time; (f) searching a time difference value of the destination in a time difference table, and storing the time difference value; (g) converting the current time received from the time loading apparatus into a system time of the destination according to the formula: system time of the destination=current time+time difference value of the destination, and converting the format of the current time into the stored time format, if the stored time format is different from the format of the current time; (h) adjusting the system time of the computer according to the conversions; (i) determining whether there is any other computer whose system time needs to be adjusted; and (j) returning to step (a) in respect of another computer, if there is any other computer whose system time needs to be adjusted.

Other objects, advantages and novel features of the present invention will be drawn from the following detailed description of a preferred embodiment and preferred method with the attached drawings, in which:

### BRIEF DESCRIPTION OF THE DRAWINGS

FIG. 1 is a block diagram of hardware configuration of a system for automatically adjusting computer system times through a COM port in accordance with a preferred embodiment of the present invention;

FIG. 2 is a block diagram of a time loading apparatus of the system of FIG. 1;

FIG. 3 is a schematic diagram of main software function modules of a computer of the system of FIG. 1; and

FIG. 4 is a flowchart of a preferred method for utilizing the system of FIG. 1.

### DESCRIPTION OF THE PREFERRED EMBODIMENTS

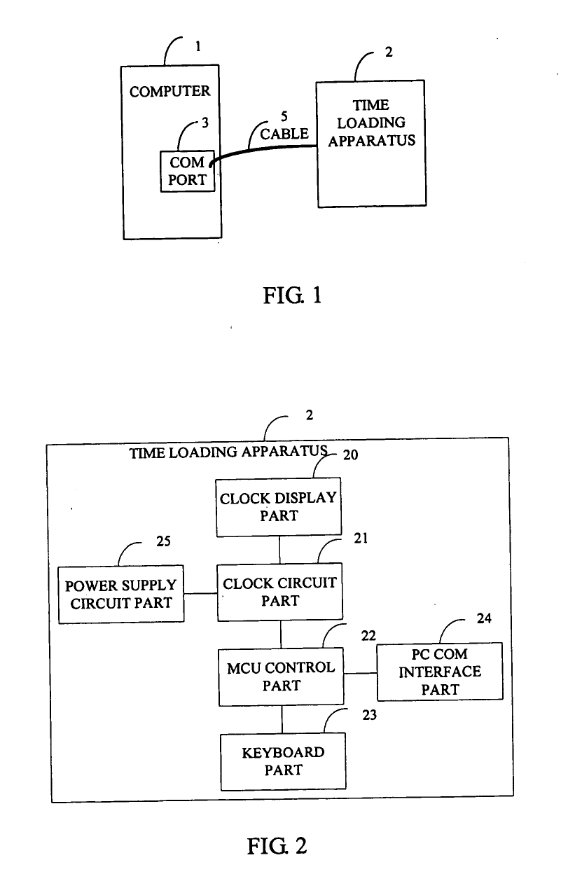

FIG. 1 is a block diagram of hardware configuration of a system for automatically adjusting system times of a computing device via a communication (COM) port (hereinafter, “the system”) in accordance with the preferred embodiment of the present invention. The system comprises a plurality of computers 1 (only one shown) whose system times are to be adjusted, a time loading apparatus 2, and a cable 5 which connects the computers 1 with the time loading apparatus 2. Each computer 1 includes a COM port 3 for the computer 1 to communicate with the time loading apparatus 2, in order to exchange and/or synchronize information between the two devices.

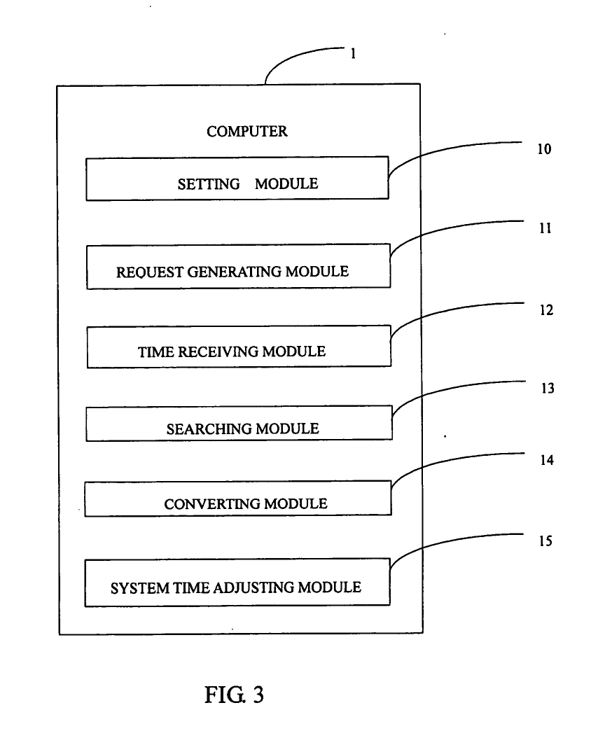

In the preferred embodiment, each computer 1 is a brand personal computer (PC) that has just been assembled at a factory, and is scheduled to be shipped to a particular marketplace. However, this should not be construed as limiting the invention in any way, and the invention and following description are equally applicable to any other computing devices whose system times need to be adjusted for any of various reasons. The computer 1 stores a time difference table containing information on time zones and time difference values. Each time zone corresponds to a time difference value. The time difference value is a difference between a base time zone (e.g., a time zone in which the computer manufacturer is located) and a designated time zone (e.g., a time zone in which the marketplace is located). The time difference value of the base time zone is set as zero, and the time difference value of any marketplace is either a positive number or a negative number. Therefore, before the computer 1 is shipped to the designated marketplace in a different time zone, the system time of the computer 1 needs to be adjusted to a system time of the marketplace according to the formula: system time of the marketplace=current time of the base time zone+time difference value of the marketplace. For example, when the computer manufacturer is in China with a current system time “10:30:20,” and the marketplace is in Japan with a time difference value “+1,” the system time of the computer 1 to be shipped to Japan is adjusted to “11:30:20” according to the formula. The computer 1 comprises a plurality of software function modules (described in detail below in relation to FIG. 3), for searching the time difference value of the marketplace in the time difference table, converting a current time received from the time loading apparatus 2 to a stored time format, and adjusting the system time of the computer 1. The stored time format may, for example, be a twelve-hour format or a twenty-four hour format. The time loading apparatus 2 is used for obtaining a current time thereof and transmitting the current time to a corresponding computer 1, according to a time obtaining request received from the computer 1.

FIG. 2 is a block diagram showing components of the time loading apparatus 2. The time loading apparatus 2 comprises a clock display part 20, a clock circuit part 21, a microprogrammed control unit (MCU) control part 22, a keyboard part 23 which controls a working status of the MCU control part 22, a PC COM interface part 24, and a power supply circuit part 25. The PC COM interface part 24 is for exchanging data between the MCU control part 22 and the computer 1. The MCU control part 22 is for (i) scanning the clock circuit part 21 at a specific frequency (e.g., a frequency of 1000 Hz) and storing scanned data on a current time, (ii) determining whether the PC COM interface part 24 has received a time obtaining request from the computer 1, and (iii) transmitting the current time to the PC COM interface part 24. The clock display part 20 is for displaying the current time provided by the clock circuit part 21. The clock circuit part 21 adopts a special count chipset.

FIG. 3 is a schematic diagram showing main function modules of any computer 1 of the system of FIG. 1. The computer 1 comprises a setting module 10, a request generating module 11, a time receiving module 12, a searching module 13, a converting module 14, and a system time adjusting module 15. The setting module 10 is for (i) determining whether there is a new setting, (ii) receiving a new setting for a time zone and/or a new setting for a time format of the computer 1, and (iii) storing the new setting(s). The request generating module 11 is for generating a time obtaining request, and transmitting the time obtaining request to the time loading apparatus 2. The time receiving module 12 is for receiving a current time from the time loading apparatus 2. The searching module 13 is for searching a corresponding time difference value of the marketplace in a time difference table, and storing the time difference value. The converting module 14 is for converting the current time received from the time loading apparatus 2 into a system time of the marketplace according to the formula: system time of the marketplace=current time+time difference value of the marketplace. The converting module 15 is also for converting a format of the current time into a stored time format. The system time adjusting module 15 is for adjusting the system time of the computer 1, and determining whether there is any other computer 1 which needs to have its system time adjusted.

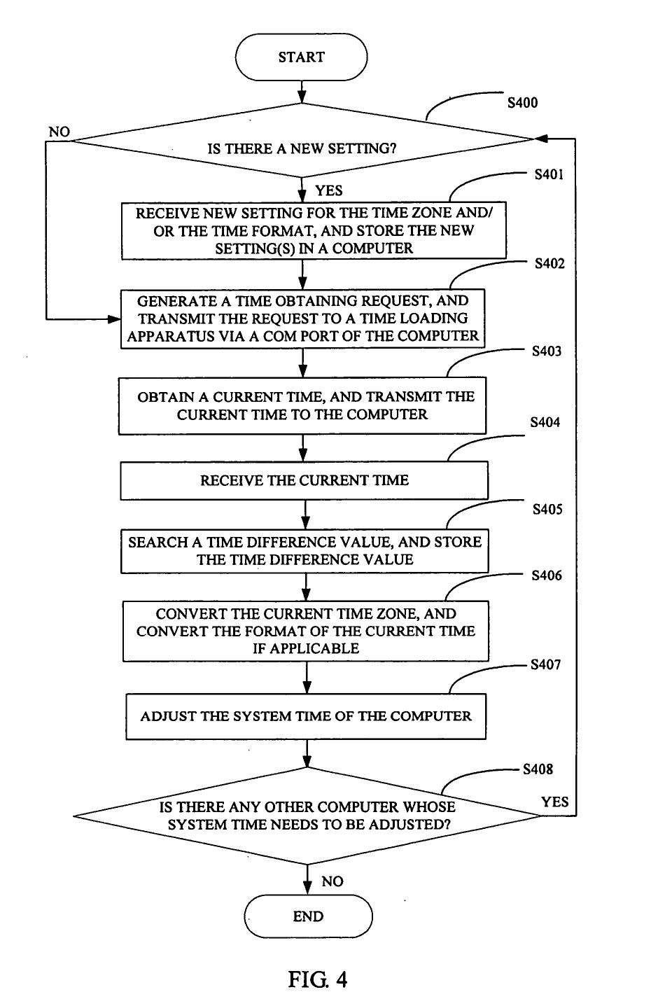

FIG. 4 is a flowchart of a preferred method for automatically adjusting a system time of one or more computers 1 by utilizing the system. In step S400, the setting module 10 determines whether there is a new setting for the computer 1 according to a target marketplace. The new setting may be for a new time zone of the target marketplace, or a new time format for the target marketplace, or both a new time zone and a new time format. It should be noted that when the system is utilized for the first time in respect of a first computer 1, a user must set a new time zone and a new time format for such computer 1. However, when the system is utilized in respect of a second or subsequent computer 1, the user may or may not set a new time zone and/or a new time format for such computer 1. If there is no new setting for the computer 1, then the computer 1 accesses a time zone and a time format previously set by the user. Such time zone and time format are available via any computer 1 which has already had its system time adjusted. The computer 1 stores such time zone and time format accordingly. Thereupon the procedure goes directly to step S402 described below.

If there is a new setting, in step S401, the setting module 10 receives the new setting for the time zone and/or the time format of the computer 1, and stores the new setting(s) in the computer 1.

In step S402, the request generating module 11 generates a time obtaining request, and transmits the time obtaining request to the time loading apparatus 2 via the COM port 3. In step S403, the time loading apparatus 2 receives the time obtaining request from the computer 1, obtains a current time from itself, and transmits the current time to the computer 1.

In step S404, the time receiving module 13 receives the current time from the time loading apparatus 2. In step S405, the searching module 14 searches a time difference value of the stored time zone (i.e., of the target marketplace) in a time difference table, and stores the time difference value.

In step S406, the converting module 15 converts the current time received from the time loading apparatus 2 into a system time of the marketplace according to the formula: system time of the marketplace=current time+time difference value of the marketplace. The converting module 15 also converts the format of the current time into the stored time format, if the stored time format is different from the format of the current time. The stored time format may, for example, be a twelve-hour format or a twenty-four hour format. In step S407, the system time adjusting module 16 adjusts the system time of the computer 1 according to the conversion result(s). In step S408, the system time adjusting module 16 determines whether there is any other computer 1 whose system time needs to be adjusted. If there is another computer 1 whose system time needs to be adjusted, the procedure returns to step S400 described above. In contrast, if the system times of all the computers 1 have been adjusted, the procedure is finished.

Further, although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for automatically adjusting computer system times via a communication port, the system comprising one or more computers whose system times are to be adjusted and a time loading apparatus connected to the computers through a cable, wherein:
each computer comprises:
a setting module for determining whether there is a new setting for the computer according to a destination of the computer;
a request generating module for generating a time obtaining request, and transmitting the time obtaining request to the time loading apparatus;
a searching module for searching a time difference value of the destination;
a converting module for converting a current time received from the time loading apparatus into a system time of the destination according to the formula: system time of the destination=current time+time difference value of the destination, and for converting a format of the current time into a stored time format if the stored time format is different from the format of the current time; and
a system time adjusting module for adjusting a system time of the computer; and
the time loading apparatus is for receiving the time obtaining request, obtaining the current time from itself, and transmitting the current time to the computer.

2. The system according to claim 1, wherein the setting module is further used for receiving one or more new settings for the computer.

3. The system according to claim 1, wherein each computer further comprises a time receiving module for receiving the current time from the time loading apparatus.

4. The system according to claim 1, wherein each computer stores a time difference table.

5. The system according to claim 4, wherein the time difference table contains information on time zones and time difference values.

6. The system according to claim 1, wherein the time difference value of the destination is a difference in time between a base time zone in which the computer is currently located and a time zone in which the destination is located.

7. The system according to claim 6, wherein the time difference value of the base time zone is set as zero, and the time difference value of the destination is either a positive number or a negative number.

8. The system according to claim 1, wherein the stored time format is selected from the group consisting of a twelve-hour format and a twenty-four hour format.

9. A computer-based method for automatically adjusting a system time of a computer via a communication port, comprising the steps of:
(a) determining whether there is a new setting for the computer according to a destination of the computer;
(b) receiving a new setting for a time zone and/or a new setting for a time format and storing the new setting(s), if there is a new setting;
(c) generating a time obtaining request, and transmitting the time obtaining request to a time loading apparatus;
(d) obtaining a current time of the time loading apparatus according to the time obtaining request, and transmitting the current time of the time loading apparatus to the computer;
(e) receiving the current time;
(f) searching a time difference value of the destination in a time difference table according to a preset time zone, and storing the time difference value;
(g) converting the current time received from the time loading apparatus into a system time of the destination according to the formula: system time of the destination=current time+time difference value of the destination, and converting a format of the current time into a new time format if the new time format is different from the format of the current time; and
(h) adjusting the system time of the computer according to the conversion(s).

10. The method as described in claim 9, further comprising the steps of:
(i) determining whether there is any other computer whose system time needs to be adjusted; and
(j) returning to step (a) in respect of another computer, if there is any other computer whose system time needs to be adjusted.

11. The method as described in claim 9, wherein the new time format and the stored time format are each selected from the group consisting of a twelve-hour format and a twenty-four hour format.

12. A method for automatically adjusting a system time of a computing device, comprising the steps of:
retrieving a setting related to regional information including time difference information for a computing device;
retrieving a current time from a predetermined time loading apparatus; and
adjusting a system time of said computing device from said current time according said setting.

13. The method as described in claim 12, further comprising the steps of adjusting said system time of said computing device based on a preset time format of said setting related to said regional information.

14. The method as described in claim 12, wherein said current time is transmitted from said time loading apparatus to said computing device via a communication (COM) port and cable.
